(19) United States
(12) Patent Application Publication
(10) Pub. No.: US 2021/0295321 A1
(43) Pub. Date: Sep. 23, 2021

(54) METHODS FOR DECENTRALIZED DIGITAL ASSET TRANSFER AND SMART CONTRACT STATE TRANSITION

(71) Applicant: Vite Labs Limited, Road Town (VG)

(72) Inventors: Chunming Liu, Beijing (CN); Lingyong Zhang, Beijing (CN); Yi Zhu, Beijing (CN)

(21) Appl. No.: 17/341,360

(22) Filed: Jun. 7, 2021

Related U.S. Application Data
(63) Continuation of application No. 16/179,149, filed on Nov. 2, 2018, now abandoned.

(51) Int. Cl. G06Q 20/38; G06Q 20/40; G06F 16/11

(52) U.S. Cl. CPC G06Q 20/389; G06Q 2220/00; G06F 16/128; G06Q 20/401

(57) ABSTRACT

Provided is a method of digital asset transfer on a distributed ledger operated on a network, wherein the distributed ledger comprises a plurality of users, each user having a transaction chain comprising a series of transactions linked by hash reference, wherein the network comprises a plurality of nodes each having a processor. The global consensus of the distributed ledger is recorded in a snapshot chain.

### CROSS-REFERENCE TO RELATED APPLICATION

This application is a continuation-in-part application of U.S. application Ser. No. 16/179,149, filed Nov. 2, 2018, the disclosure of which is incorporated herein by reference.

### FIELD OF THE INVENTION

The present invention generally relates to decentralized digital assets transfer, smart contract state transition and decentralized applications.

### BACKGROUND

A decentralized application (dApp) platform is a distributed system with final consistency of states among the nodes. dApp platforms have been used to facilitate the transfer of digital assets, such as cryptocurrencies, and to execute a set of smart contracts which have their own internal states and transition logics. In realistic scenarios, what is stored in the state of smart contracts is a set of completed data in a dApp, which has large volume and cannot be transmitted between nodes. Therefore, nodes need to transfer a set of transactions to achieve the consistency of the final state. Such a set of transactions are organized into a specific data structure, which usually referred to as ledgers. A typical exemplary ledger is a block chain, which has been running well in Bitcoin and Ethereum.

FIG. 1 illustrates a dApp platform 100 with a block chain ledger structure 105. The dApp platform 100 includes users 101, 102 and 103. It should be note that though three users are shown in FIG. 1, the dApp platform 100 may include less or more users. As can be seen in FIG. 1, transactions can be occurred between users. For example, FIG. 1 shows a transaction 104 which transfers an amount of digital asset from the user 101 to the user 102. For each transaction, the balance of the user from which the digital asset is transferred may be checked to verify whether the balance can cover the amount included in the transaction. For example, the balance of the user 101 can be checked to determine whether the balance of the user 101 can cover the amount included in the transaction 104, and only if the balance of the user 101 can cover the amount included in the transaction 104, the transaction 104 can be further proceeded.

In addition, in the platform 100, each transaction may be authenticated whether the transaction is created by the true user. An exemplary scheme for such authentication is “digital signature”. A valid digital signature gives other users and nodes in the platform 100 a reason to believe that the transaction was created by the true user, that such user cannot deny having created the transaction and that the transaction was not altered in transit. A user in the platform 100 may have a private key that is only known to the user, and one or more public keys that are generated based on the private key and known to all the users and nodes in the platform 100. For example, when the user 101 creates the transaction 104, the user 101 may generate a digital signature based on the private key of the user 101 and the transaction 104, and sends the transaction 104 out with the digital signature. Other users and nodes in the platform 100, given the transaction 104, the public key of the user 101 and the digital signature, can authenticate whether the transaction 104 is created by the user 101. Also, since the private key is only known to the user 101, the user 101 cannot deny that the transaction 104 was created by the user 101. Examples of digital signature algorithm include, without limitation, RSA based signature schemes (e.g., RSA-PSS), DSA, Edwards-curve digital signature algorithm, Rabin signature algorithm, aggregate signature, etc.

The platform 100 also includes a block chain 105 which includes a list of blocks 105₁ to 105ₙ that are linked and secured using cryptography for recording transactions occurred in the platform 100. Arrows shown in the block chain 105 denote dependencies between blocks, whereas a-b indicates that a depends on b. In other words, the block a contains a hash reference to the block b. The block chain 105 can be managed by a peer-to-peer network 106 that includes a plurality of nodes 107. Each of the plurality nodes 107 is allowed to generate a new block for the block chain 105 (will be discussed in detail below) and link the new block to the block chain 105, and each new block can record some or all of the most recent transactions occurred in the platform 100 that have not yet been recorded in any prior block.

Since each node of the platform is allowed to generate a new block and link the new block to the block chain, it is possible that two or more nodes generate two or more new blocks and linked such two or more new blocks to the block chain at the same time, as shown by a block 202 and block 203 in FIG. 2. It means that the block chain 200 diverges into two paths 205 and 206, and the platform of the block chain 200 enters into different states. When this happens, it is usually called a “fork.” When the fork occurs, each node needs to select one from the forked paths and discard the unselected path(s). In order to ensure the consistency of the state, the plurality of nodes need to use the same algorithm to complete the selection. This algorithm is called the consensus algorithm. In a platform with a block chain ledger structure, a consensus algorithm called proof-of-work (PoW) is usually used. The PoW algorithm will be illustrated below with FIG. 3.

FIG. 3 shows an exemplary data structure of a block 300 included in a block chain. For illustration purpose, not all the data of a block in the realistic scenarios are shown in FIG. 3. As can be seen, the block 300 includes a block head 301 and a block body 302. The block body 302 includes date of all the transactions to be recorded in the block 300. The block head 301 may contain a previous block ID 303, a timestamp 304, a Merkle root 305 and a nonce 306.

The previous block ID 303 may include a hash of the data included in the block head of the previous block. The term “hash” refers to a mathematical algorithm that maps data of arbitrary size to a bit string of a fixed size, and is designed to be a one-way function, that is, a function which is infeasible to invert. The only way to recreate the input data from an ideal cryptographic hash function's output is to attempt a brute-force search of possible inputs to see if they produce a match or use a rainbow table of matched hashes. A hash function is a deterministic function, in which the same input will produce the same output. Examples of cryptographic hash include SHA hash function, e.g., SHA-0, SHA-1, SHA-2, SHA-3 and SHA256 function. Obviously, when generating the block 300, the previous block ID 303 is known and definite.

The timestamp 304 indicates the time that the block 300 is generated. All the transactions recorded in the block body 302 can be organized into a Merkle tree, and the root of such Merkle tree can be included in the block head 301 as the Merkle root 306. Obviously, the timestamp 305 and the Merkle root 306 are both known and definite when generating the block 300.

That is, when generating the block 300, the only indefinite data included in the block head 301 is the nonce 306. In other words, generating a new block means computing a nonce included in the block head of the new block.

As discussed above, since each node of the platform is allowed to generate a new block and link the new block to the block chain, it is possible that two or more nodes generate two or more new blocks at the same time. To reduce that possibility, the nonce included in the block head is required to satisfy a mathematic equation. For example, it may require that:

SHA(previous block ID+timestamp+a Merkle root+nonce)≤Target Bit String Equation 1)

That is, the SHA function result of the previous block ID, the timestamp, the Merkle root and the nonce included in the block head of a block shall fall into a scope, i.e., equal or less than a target bit string. Since the SHA function is a one-way function which is infeasible to invert, with the known and definite previous block ID, timestamp and Merkle root, the only way to obtain a satisfying nonce is attempting a brute-force search. All the nodes in the platform may compete to find a satisfying nonce. After a node finds a nonce, other nodes are required to stop their brute-force searches and can directly input the nonce into the above Equation 1) to verify whether the nonce satisfies the Equation 1). If so, the finder of the nonce is allowed to link the block including the nonce to the block chain. The target bit string can be defined as relatively small so that the difficulty of computing a satisfying nonce is high. On the contrary, it is easy to verify whether a nonce satisfies the Equation 1) by directly inputting the nonce to the Equation 1). Since the difficulty of computing a satisfying nonce is high, the possibility that two or more nodes generate different new blocks at the same time is low.

Referring back to FIG. 2, when a fork occurs, i.e., two different block 202 and block 203 are generated at the same time, other nodes can voluntarily choose to further generate new blocks based on either of the block 202 and block 203. It can be understood that since the possibility that two or more nodes generate different new blocks at the same time is low, it is hardly possible that two or more nodes continually generate different new blocks for the forked paths at the same time. Therefore, nodes in the platform can finally select the longest path from the forked paths and discard other paths. In the case of FIG. 2, after the block 202 and the block 203 are generated, a new block 204 is then generated based on the block 202, so the longer path 205 is finally selected and the path 206 is discarded. Transactions that recorded in the blocks 203 of the path 206 can be released and then recorded in blocks that further generated in the path 205.

With the above mechanism, once recorded, the data in any given block cannot be altered retroactively without the alteration of all subsequent blocks, which requires collusion of the network majority. Since new blocks are continually generated, the difficulties of altering the data in a prior block increases with the block chain grows. Therefore, the above mechanism that incorporating PoW consensus algorithm has a good security and has been running well in Bitcoin and Ethereum. However, there are two main problems in this mechanism. The first is that solving the abovementioned mathematical problem requires a large amount of computing resources, which results in a waste of energy. The second is that it may take a relatively long time to compute a satisfying nonce to generate a new block, thus the system's overall throughput is limited. At present, the transactions-per-second (TPS) of Ethereum is about 15, which is totally unable to meet the needs of decentralized applications.

With the proliferation of digital assets, there is an increased need to develop a universal dApp platform that can solve the problems above and has high throughput and low latency while taking into account security.

### SUMMARY

The present disclosure in one aspect provides a method for digital assets transfer on a distributed ledger operated on a network, wherein the distributed ledger comprises a plurality of users, each user having a transaction chain comprising a series of transactions linked by hash reference, wherein the network comprises a plurality of nodes each having a processor. The method comprises: receiving, by a first node of the network, a new transaction of a first user broadcast in the network; verifying, by the first node, that the new transaction of the first user is valid; in response to that the new transaction is valid, linking the new transaction by hash reference to a latest transaction of a first transaction chain of the first user; taking, by a second node, a snapshot of the first user, said snapshot comprising the first user's balance in the new transaction of the first user and a hash of the new transaction of the first user; generating, by the second node, a new snapshot block; storing, by the second node, the snapshot of the first user in the new snapshot block; and linking, by the second node, the new snapshot block to a latest snapshot block of a snapshot chain by referring to a hash of the latest snapshot block. The first node and the second node can be the same node or different nodes.

In some embodiments, the distributed ledger has a structure of directed acyclic graph.

In some embodiments, the first transaction is a request transaction that sends an amount of digital asset to a second account, and the verifying step comprises: verifying that a hash of a previous transaction linked to the latest transaction is valid; and verifying that the first user's balance included the latest transaction is not less than the amount of digital asset.

In some embodiments, the first transaction is a response transaction that receives an amount of digital asset from a corresponding request block of a second account, and the verifying step comprises: verifying that a hash of a previous block linked to the latest block is valid; and verifying that the hash of the corresponding request block is valid.

In some embodiments, the new snapshot block is signed by the second node.

In some embodiments, the method further comprises broadcasting the new snapshot block to the network.

The present disclosure in another aspect provides a non-transitory readable storage medium including instructions, when executed by a processor in a node of a network, causes the processor to perform a method of digital asset transfer on a distributed ledger, wherein the distributed ledger comprises a plurality of users, each user having an transaction chain comprising a series of transactions linked by hash reference.

In yet another aspect, the present disclosure provides a system for digital asset transfer on a distributed ledger, wherein the distributed ledger comprises a plurality of users, each user having a transaction chain comprising a series of transactions linked by hash reference, the system comprising a network which comprises a plurality of nodes, each node having a processor to perform a method

### BRIEF DESCRIPTION OF DRAWINGS

The accompanying drawings, which are incorporated herein, form part of the specification. Together with this written description, the drawings further serve to explain the principles of, and to enable a person skilled in the relevant art(s), to make and use the present invention.

FIG. 1 illustrates a dApp platform with a block chain ledger structure.

FIG. 2 illustrates a fork occurred in a block chain.

FIG. 3 illustrates an exemplary data structure of a block in a block chain.

FIG. 4 illustrates an exemplary embodiment of transactions on a distributed ledger having a block lattice structure.

FIG. 5 illustrates the split of an exemplary transfer transaction into a request transaction and a response transaction.

FIG. 6 illustrates an exemplary embodiment of transactions on a distributed ledger having a block lattice structure and an exemplary snapshot chain.

FIGS. 7A and 7B illustrate an exemplary snapshot chain before the compression (FIG. 7A) and after compression (FIG. 7B).

### DESCRIPTION OF THE INVENTION

The following description of the disclosure is merely intended to illustrate various embodiments of the disclosure. As such, the specific modifications discussed are not to be construed as limitations on the scope of the disclosure. It will be apparent to one skilled in the art that various equivalents, changes, and modifications may be made without departing from the scope of the disclosure, and it is understood that such equivalent embodiments are to be included herein. All references cited herein, including publications, patents and patent applications are incorporated herein by reference in their entirety.

### Definition

The following definitions are provided to assist the reader. Unless otherwise defined, all terms of art, notations and other scientific or medical terms or terminology used herein are intended to have the meanings commonly understood by those of skill in the art. In some cases, terms with commonly understood meanings are defined herein for clarity and/or for ready reference, and the inclusion of such definitions herein should not necessarily be construed to represent a substantial difference over the definition of the term as generally understood in the art.

As used herein, the singular forms “a”, “an” and “the” include plural references unless the context clearly dictates otherwise.

As used herein, an “address” or “network address” refers to an identifier for a node or host on a telecommunication network. Typically, addresses are designed to be unique identifiers across the network. Examples of network addresses include, without limitation, IP address, IPX address, MAC address, etc.

A “block,” as used in the context of a distributed ledger, refers to a file where data pertaining to the distributed ledger is recorded. A block can record some or all of the most recent transactions in the distributed ledger that have not yet entered any prior block.

“Blockchain” or “block chain” refers to a continually growing list of records, i.e., blocks, that are linked and secured using cryptography. Each block in the block chain typically contains a cryptographic hash of the previous block, a timestamp, transaction data and a nonce. A blockchain, by design, is inherently resistant to modification of the data. Blockchain can be used as an open, distributed ledger that records transactions between two parties efficiently and in a verifiable and permanent way. When used as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

“Block lattice” refers to a type of DAG (Directed Acyclic Graph) based architecture. With this type of architecture, each individual user on the network possesses their own chains, which is controlled by the individual's private keys or a group of delegated nodes.

The term “cryptographic hash” or “hash” refers to a mathematical algorithm that maps data of arbitrary size to a bit string of a fixed size, and is designed to be a one-way function, that is, a function which is infeasible to invert. The only way to recreate the input data from an ideal cryptographic hash function's output is to attempt a brute-force search of possible inputs to see if they produce a match or use a rainbow table of matched hashes. A hash function is a deterministic function, in which the same input will produce the same output. Examples of cryptographic hash include SHA hash function, e.g., SHA-0, SHA-1, SHA-2, SHA-3 and SHA256 function.

The term “consensus algorithm” as used herein refers to a mechanism or process through which the members in a distributed ledger reaches agreement. Examples of consensus algorithm includes without limitation, proof-of-work (PoW), proof-of-stake (PoS), delegated proof-of-stake (DPoS), transaction as proof-of-stake (TAPoS), Byzantine fault tolerance (BFT).

As used herein, a “digital signature” refers to a mathematical scheme for presenting the authenticity of digital messages or documents. A valid digital signature gives a recipient reason to believe that the message was created by a known sender, that the sender cannot deny having sent the message and that the message was not altered in transit. A typical digital signature scheme consists of three algorithms: a key generation algorithm that selects a private key uniformly at random from a set of possible private keys and outputs the private key and a corresponding public key; a signing algorithm that, given a message and a private key, produces a signature; and a signature verification algorithm that, given the message, public key and signature, either accepts or rejects the message's claim to authenticity. Examples of digital signature algorithm include, without limitation, RSA based signature schemes (e.g., RSA-PSS), DSA, Edwards-curve digital signature algorithm, Rabin signature algorithm, aggregate signature, etc.

“Distributed ledger” refers to a database that is consensually shared and synchronized across network spread across multiple nodes, sites, institutions or geographies. Distributed ledger allows transactions to have public witnesses, thereby making a cyberattack more difficult. A peer-to-peer network is usually required as well as consensus algorithm to ensure replication in nodes is undertaken. One form of distributed ledger is the blockchain system, which can be either public or private. Distributed ledger may employ a system with various structure, such as block chain structure and block lattice structure, to provide secure and valid achievement of distributed census.

A “fork” as used herein refers to a situation in which a distributed ledger diverges into two potential paths forward.

“Merkle root” refers to the root node of a Merkle tree. A Merkle tree, or hash tree, is a tree in which every leaf node is labelled with the hash of a data block and every non-leaf node is labelled with the cryptographic hash of the labels of its child nodes. Thus, a Merkle root is a descendent of all the hashed pairs in the tree.

As used herein, a “smart contact” refers to a computer protocol intended to digitally facilitate, verify or enforce the negotiation or performance of a contract. Smart contracts allow the performance of credible transactions without third parties. These transactions are trackable and irreversible. For example, smart contracts implemented on Ethereum may include those that defines the interfaces and events, that registers wallets and relays, that validates order rings, transfers tokens for settlement and emits events, that enables multi-signature ownership, and that transfers tokens on behalf of users.

As used herein, a “snapshot” or “state snapshot” refers to the state of a system, e.g., a distributed ledger or an account in the distributed ledger, at a particular point of time. In the context of an account in a distribute ledger, a state snapshot may include the balance of an account. The state snapshot may also include the hash of the last block in each account chain. In some examples, the state snapshot may also include the Merkle root of the contract state.

A “node” refers to a software, a hardware or a firmware that conforms to the protocol of a dApp platform (for example, the Bitcoin protocol, the Ethereum protocol or Nano protocol) and participates in the network of the dApp platform. A node manages the ledger and any accounts the node may control, if any. A node may either store the entire ledger or snapshot chain, or only store a pruned history containing only the last few blocks of the blockchain, each account's transaction chain or snapshot chain. When setting up a new node, it is recommended to verify the entire history and prune locally. A node may also generate a block for the blockchain, transaction chain or snapshot chain according to a predefined rule.

The present disclosure in one aspect provides methods and systems for facilitating digital asset transfer and smart contract state transition. It is understandable to those skilled in the art that such methods are implemented in a distributed network which may include one or more computer servers and devices that are connected and communicated with each other. Correspondingly, the systems disclosed herein include both hardware, such as computer servers and devices, and software. Suitable computer servers include, without limitation, a rack server, a tower server, a miniature server, a blade server, a mini rack server, a mobile server, an ultra-dense server, a super server, and may include various hardware components, for example, a mother board, a processing unit, memory systems, hard drives, network interfaces, power supplies, etc. The computer systems or devices may run an operating system including any commercial available server operating system. The computer servers and devices may be connected and communicated through various types of networks, for example, computer networks, telecommunications networks, wireless networks, and any combinations of these and/or other networks.

### Ledgers

In the field of digital asset transaction, the role of ledgers is to determine the order of transactions, which will affect the following two aspects: consistency of status and effectiveness of hash. Since the state of the system is not a conflict-free replicated data types (Shapiro Marc et al., 2011), not all transaction is exchangeable, and the sequence of different transaction execution may lead to the system entering a different world state. In the ledger, the transaction will be packaged into blocks, which contain hash that is referenced to each other. The order of transactions affects the connectivity of hash references in the ledgers. The greater the scope of this impact, the greater the cost of tampering with transactions. This is because any change to a transaction must be rebuilt by hash, which directly or indirectly refers to the block of the transaction.

Thus, the design of the ledger has two main objectives: reducing the false fork rate and tamper proof.

The reduction of the false fork rate can be achieved by establishing an equivalent class and combining a group of accounts that lead the system into the same state into a single account. In other words, partial ordering relationship between transactions should be minimized to allow more transactions to be exchanged by sequence.

On the other hand, to increase the cost of tampering with transactions, it is necessary to maintain the partial order relationship between transactions as much as possible in order to expand the scope of tampering.

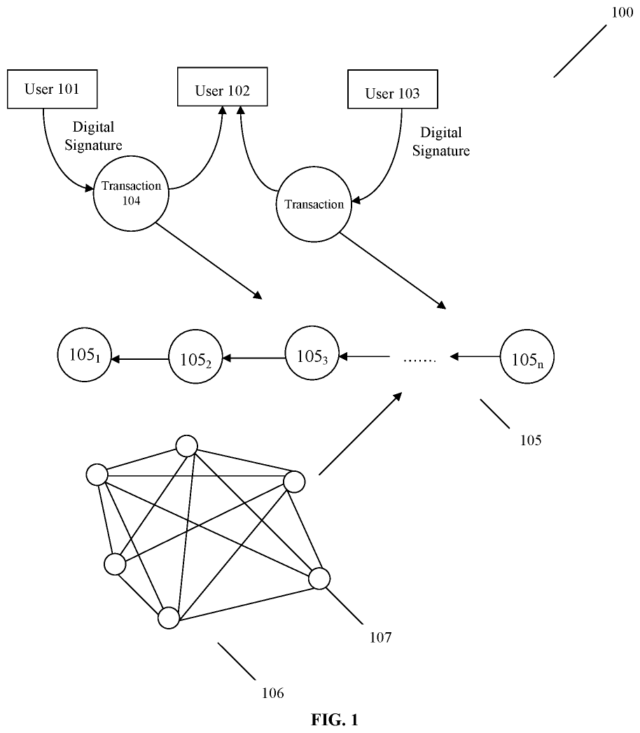

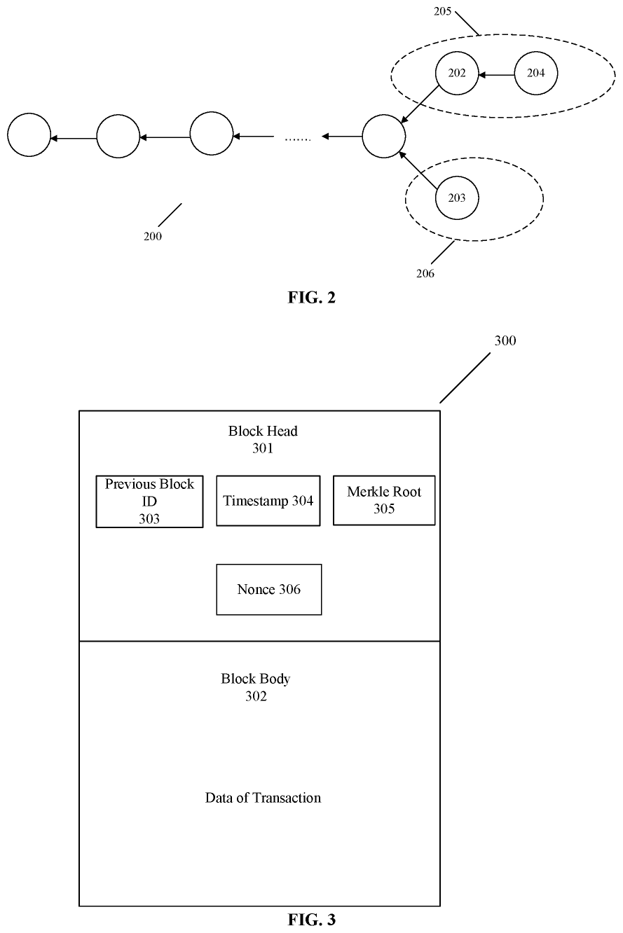

Obviously, the two main objectives above are contradictory, and the necessary trade-offs must be made when designing the ledger structure. The block chain structure as discussed with respect to FIG. 1 to FIG. 3 is a ledger structure with the best tampering proof features.

### Block Lattice Structure

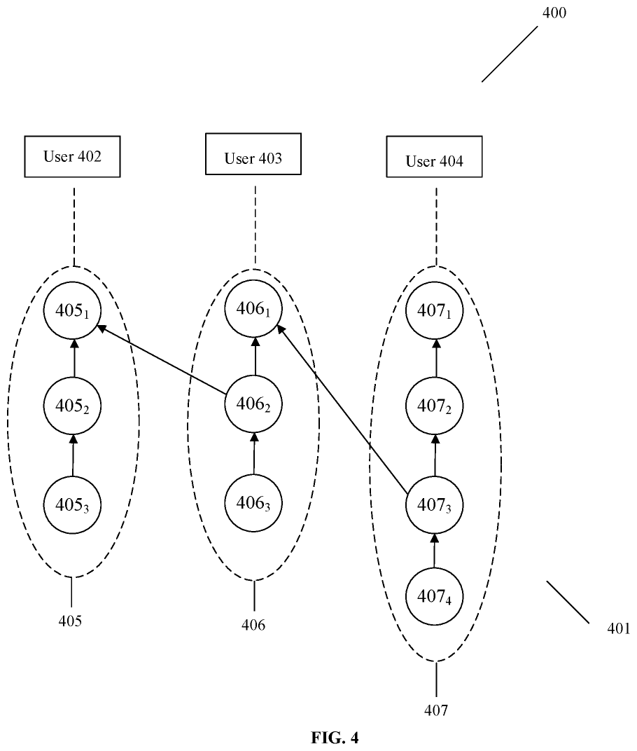

Instead of the block chain structure, the method and system of the present application includes a block lattice structure. FIG. 4 illustrates a dApp platform 400 that includes a block lattice structure 401 according to one embodiment. As can be seen, the dApp platform 400 includes users 402, 403 and 404. It should be note that though three users are shown in FIG. 4, the dApp platform 400 may include less or more users. Different from the platform 100 with a block chain structure shown in FIG. 1, the dApp platform 400 includes a block lattice structure 401. With the block lattice 401, all transactions are grouped into users and organized into a chain of transactions in the same user.

In a ledger having a block lattice structure (for example, the block lattice structure 401), each transaction only affects the state of a user, which is referred to as having a single degree of freedom constraint for a transaction. In contrast, in a ledger having a blockchain structure, such as Bitcoin and Ethereum, a transaction may affect the state of multiple accounts. For example, a transaction in Bitcoin will change the state of both the sender and the recipient; the Ethereum may change the state of more than two users in a message call.

In a ledger having a block lattice structure, the relationship between transactions can be simplified. Any two transactions are either orthogonal (the users of the two transactions are different) or parallel (the users of the two transactions are the same). This provides conditions for grouping transactions according to users.

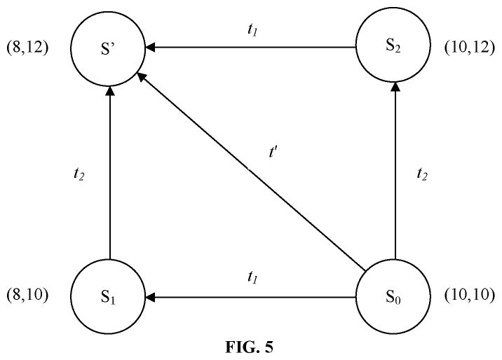

In the platform 400, any transfer transaction may be split into a sending transaction and a receiving transaction. As shown in FIG. 5, suppose a user A and a user B have 10 units of digital asset respectively. The initial state of the system is s₀=(10, 10). When the user A wants to transfer 2 units of digital asset to the user B, in the model of a platform with block chain structure (for example, the platform 100), a transaction t′ can make the system go directly into the final state:

$${s}_{0} {\to }^{{t}^{′}} {s}^{′} .$$

In a platform having the block lattice structure (for example, the platform 400), transaction t′ changes the status of two users, which did not conform to the principle of single degree of freedom. Therefore, the transaction t′ must be split into two transactions:

1) A transaction t₁ that represents sending of 2 units of digital asset by the user A;

2) A transaction t₂ that represents receiving of 2 units of digital asset by the user B;

In this way, from the initial state s₀ to the final state s′, there could be two different paths

$${s}_{0} {\to }^{{t}_{1}} {s}_{1} {\to }^{{t}_{2}} {s}^{′} and {s}_{0} {\to }^{{t}_{2}} {s}_{2} {\to }^{{t}_{1}} {s}^{′} .$$

These two paths are respectively passed through the intermediate state s₁ and s₂, and these two intermediate states are the mapping of the final state s′ in the two users dimensions. In other words, if the state of only one of the users is concerned, only all the transactions that correspond to the user need to be executed, and no transactions of other users need to be carried out.

Therefore, a transfer transaction can be split into a sending transaction and a receiving transaction. Similarly, a message call within a smart contract can be split into a contract request transaction and a contract response transaction.

A sending transaction or contract request transaction, collectively refer to as a “request transaction”; a receiving transaction or a contract response transaction, collectively refer to as a “response transaction”. A request transaction and a corresponding response transaction are called a transaction pair.

Referring back to FIG. 4, circles represent transactions, and arrows denote dependencies between transaction, whereas a→b indicates that a depends on b. In other words, transaction a contains a hash reference to transaction b. Transactions are divided into request and response transactions, each of which corresponds to a separate transaction. Each user 402, 403 and 404 respectively corresponds to transaction chains 405, 406 and 407, which are linked by hash references (i.e., each transaction refers to the hash of its immediately previous transaction except for the first transaction in the chain). A response transaction also refers to the hash of its corresponding request transaction.

Referring to FIG. 4, the transaction chain 405 of the user 402 includes at least transactions 405₁, 405₂ and 405₃, wherein the transaction 405₂ depends on the transaction 405₁ and the transaction 405₃ depends on the transaction 405₂. A transaction chain 406 of the user 403 includes at least transactions 406₁, 406₂ and 406₃, wherein the transaction 406₂ depends on the transaction 406₁ and the transaction 406₃ depends on the transaction 406₂. A transaction chain 407 of the user 404 includes at least the transactions 407₁, 407₂, 407₃, and 407₄, wherein the transaction 407₂ depends on the transaction 407₁, the transaction 407₃ depends on the transaction 407₂ and the transaction 407₄ depends on the transaction 407₃. The transaction 406₂ representing a response transaction also contains a hash reference to the transaction 405₁ representing a request transaction, and the transaction 407₃ representing a response transaction also contains a hash reference to the transaction 406₁ representing a request transaction.

A transaction in the transaction chain may include the balance of the respective user after performing the transaction. For example, the transaction 406₂ may include the balance of the user 403 after performing the transaction 406₂. Before performing a request transaction, the balance of the corresponding user may be checked to determine whether the balance of the user can cover the amount of the request transaction. If so, the request transaction can be further proceeded; if not, the request transaction can be forbidden. After performing each transaction, the balance of the corresponding user may be updated. For example, if a user performs a request transaction, the balance of the user is deducted by the amount of the request transaction; if a user performs a response transaction, the balance of the user is increased by the amount of the response transaction.

In some embodiments, the transactions in each of the chains 405-407 can only be generated by the respective users 402-404. The greatest advantage of this mechanism is to reduce the probability of fork. Because only one user has the right to generate transactions, the only possibility of fork is that the user initiates a double spend attack personally or a program error. The disadvantage of this mechanism is that the user nodes must be online before they can pack the transaction.

In some embodiments, a user may delegate a set of nodes of the network managing the platform 400 to generate the transactions for the user. The delegated nodes can generate transactions based on an algorithm called Delegated proof of Stake (DPOS). Each of the delegated nodes can generate a new transaction based on a predetermined order. For example, a user may delegate 3 nodes to generate transactions for the user. Among the three delegated nodes, Node 1 generates a first transaction at a time point t₁, Node 2 generates a second transaction referring to the first transaction at a time point t₂, Node 3 generates a third transaction referring to the second transaction at a time point t₃, wherein the time point t₃>t₂>t₁. The transaction that is not generated according to the order may be discarded. The user can replace a delegated node with a new node. For example, if a delegated node tries to generate a transaction at an incorrect order, this node may be replaced by the user with a new node.

Since the PoW consensus algorithm as discussed above with respect to FIG. 1 to FIG. 3 is not incorporated in the platform 400, no difficult mathematic problem needs to be solved before recording a transaction, so the platform 400 may not result in a waste of energy and have a higher overall throughput.

### Snapshot Chain

When the ledger is forked, the result of consensus may swing between two forked ledgers. For example, based on a blockchain structure, if a node receives a longer forked chain, the new fork will be selected as the consensus result, and the original fork will be abandoned and the transaction on the original fork will be rolled back. In such a system, transaction rollback is a very serious event, which will lead to double spend. Just imagine that a merchant receives a payment, provides goods or services, and after that payment is withdrawn, the merchant may suffer losses. Therefore, when a user receives a payment transaction, it is necessary for the user to wait until the system “confirms” the transaction to ensure that the probability of rolling back is low enough.

The probability of transaction rollback decreases with time due to the hash reference relationship in the structure. As discussed supra, when the design of the ledger has better tampering-proof characteristics, rolling back a transaction needs to reconstruct all subsequent blocks of the transaction in the block. As new transactions are constantly being added to ledgers, there are more and more successive nodes in a transaction, so the probability of being tampered with will decrease.

In the block-lattice structure, as the transaction is grouped by users, and a transaction will only be attached to the end of the account chain of its own account, and the transaction generated by most other users will not automatically become a successor of this transaction. Therefore, it is necessary to design a mechanism reasonably to avoid potential risk of double spend.

The previous platform such as Nano adopts a voting-based mechanism, in which transaction is signed by a set of representative nodes selected by a group of users. Each representative node has a voting weight. When the signature of a transaction has enough weight, it is believed that the transaction is confirmed and then is allowed to be linked to the corresponding chain.

There are following problems in this mechanism. First, if there are not enough representative nodes online, voting from the majority cannot be guaranteed, and it is possible that a user will never collect enough votes necessary to confirm a transaction. Moreover, if plurality is accepted within fixed voting period, different voting results may be watched by peers located at different spots of the network topology due to poor connection, and cause a split. Second, the probability that transactions are rolled back does not decrease with time. This is because at any time, the cost of overturning a historical voting is the same. Finally, the historical voting results are not persisted into a public distributed ledger but are stored only in the local storage of peers. In other words, these results are not traceable. When a peer requests the ledger data from other peers, there is no trustful way to ensure the data is consistent.

To solve these problems, the method of this disclosure uses a snapshot chain independent of the distributed ledger to store the state snapshots of the ledger. The snapshot chain is a chain structure composed of snapshot blocks, and each of the snapshot block (except for the genesis snapshot block) refers to the hash of the previous snapshot block. Each snapshot block records the latest state snapshot of each user chain. In certain embodiments, the state snapshot includes the balance of each user and the hash of the last transaction in each user chain. In certain embodiments, the state snapshot also includes the Merkle root of the contract state. The first snapshot block in the snapshot chain is called the “genesis snapshot”, which stores the snapshot of the genesis block of at least one user.

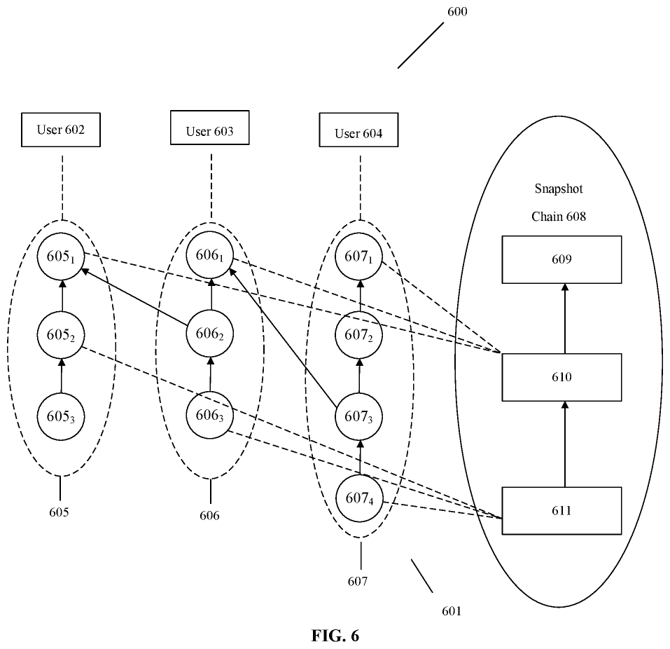

FIG. 6 illustrates a platform 600 including a block lattice 601 and a snapshot chain 608 according to one embodiment. The block lattice 601 may have a similar structure as the block lattice 401 and will not be repeated herein for simplicity. Each transaction will not be confirmed until being snapshot by the snapshot chain 608 (will be discussed in detail below) so as to remedy the security flaws of the block lattice structure.

The snapshot chain 608 comprises a series of snapshot blocks (609, 610 and 611) organized in a chain structure, with each snapshot block refers to the hash of the previous snapshot block (the snapshot block 610 refers to the hash of the snapshot block 609, and the snapshot block 611 refers to the hash of the snapshot block 610). A snapshot block stores a state snapshot of the block lattice 601. Referring to FIG. 6, snapshot block 610 stores state snapshots of transactions 605₁, 606₁ and 607₁; snapshot block 611 stores state snapshots of transactions 605₂, 606₃ and 607₄.

The users of the platform 600 may select several nodes of the network managing the platform 600 to generate snapshot blocks based on the DPOS algorithm. For example, 25 proxy nodes can be selected by the users to generate snapshot blocks. Each of the selected nodes can generate a new snapshot block based on a predetermined order. For example, Proxy Node 1 generate a first snapshot block at a time point t₁, Proxy Node 2 generate a second snapshot block referring to the first snapshot block at a time point t₂, Proxy Node 3 generates a third snapshot block referring to the second snapshot block at a time point t₃ . . . Proxy Node 25 generates a twenty-fifth snapshot block referring to the twenty-fourth snapshot block at a time point t₂₅, wherein t₂₅> . . . >t₃>t₂>t₁. The snapshot block that is not generated according to the order may be forbidden, and the order can be adjusted periodically. If a proxy node tries to generate a snapshot block at an incorrect order, this proxy node may be replaced by the users with a new proxy node. The platform 600 may specify an interval of the snapshot block generation, for example, generating a snapshot block at intervals of 1 second. With this mechanism, the overall throughput of the platform 600 will not be substantially limited.

In the platform 600, if a transaction is snapshot by the snapshot chain 608, the transaction is confirmed. The depth of the snapshot block when the transaction is first snapshotted is called the confirmation number of the transaction. Rolling back a transaction needs to reconstruct all snapshot blocks after the first snapshot block of the transaction, so when the confirmation number increases as the snapshot chain grows, the possibility of the double-spend attack decreases. In certain embodiments, users can choose customized confirmation number to wait to meet the desired confidence level according to the specific scenario. For example, users that usually deal with transactions in small amount may set a relatively low confirmation number to ensure confirmation speed; on the contrary, users that usually deal with transactions in huge amount may set a relatively high confirmation number to ensure security.

The snapshot chain itself relies on a consensus algorithm. In certain embodiments, if the snapshot chain is forked, the longest fork is chosen as a valid fork. When the snapshot chain is switched to a new fork, the original snapshot information will be rolled back. In this situation, the result of original consensus on the ledger was overturned and replaced by the new consensus result.

In one embodiment, each node in the network may store a copy of the entire snapshot chain. In another embodiment, a portion of the nodes in the network are configured to store a copy of the entire snapshot chain while the other portion of the nodes are configured to store a pruned history containing only the last few blocks of the snapshot chain, according to the storage capacity of each node. The portion of the nodes that only store a pruned history may request an antecedent snapshot block from other nodes. In a further embodiment, only a portion of the nodes in the network are configured to store a copy of the snapshot chain. The nodes that do not store a copy of the snapshot chain may request other nodes to authenticate a transaction.

The snapshot chain remedies the security flaws of the block lattice structure. In certain embodiments, if an attacker wants to generate a double spend transaction, in addition to rebuilding the hash reference in the block lattice structure, it also needs to rebuild in the snapshot chain for all the blocks after the first snapshot block of the transaction and need to produce a longer snapshot chain. In this way, the cost of attack will be greatly increased.

In certain embodiments, if all account states need to be saved in every snapshot block in snapshot chain, the storage space will be very large. Therefore, compression of the snapshot chain may be needed.

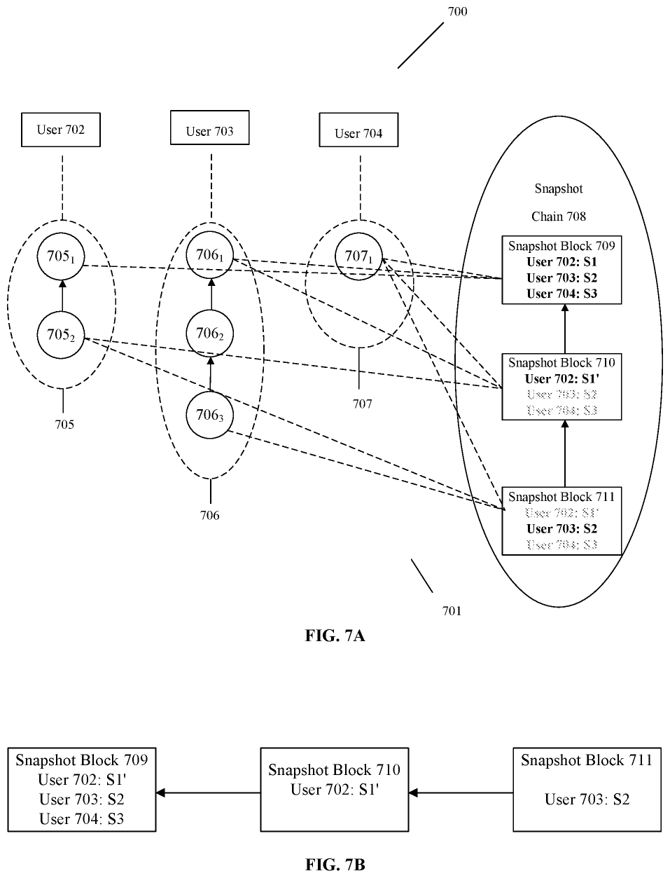

FIGS. 7A and 7B illustrate the compression of snapshot in an exemplary embodiment. The basic approach of compressing snapshot chain storage space is to use incremental storage: a snapshot block only stores data that is changed compared to the previous snapshot chain. If there is no transaction for a user between the two snapshots, the latter snapshot will not save the data of the user. FIG. 7A illustrates the snapshot chain before compression, in which all user states are stored in snapshot block. Referring to FIG. 7A, a transaction chain 705 includes at least a transaction 705₁ and a transaction 705₂; a transaction chain 706 includes at least a transaction 706₁, a transaction 706₂ and a transaction 706₃; a transaction chain 707 includes at least a transaction 707₁. A snapshot chain 708 includes at least a snapshot block 709, a snapshot block 710 and a snapshot block 711. The snapshot block 709 stores state snapshots of the transaction 705₁ (i.e., S₁), of the transaction 706₁ (i.e., S₂), and of the transaction 707₁ (i.e., S₃); The snapshot block 710 stores state snapshots of the transaction 705₂ (i.e., S₁′), of the transaction 706₁ (i.e., S₂), and of the transaction 707₁ (i.e., S₃); The snapshot block 711 stores state snapshots of the transaction 705₂ (i.e., S₁′), of the transaction 706₃ (i.e., S₂″), and of the transaction 707₁ (i.e., S₃). FIG. 7B illustrates the snapshot chain after compression, in which only the final state of each snapshot of a user is stored when snapshotting, and the intermediate state will not be taken into account. Referring to FIG. 7B, the snapshot block 709 stores state snapshots of the transaction 705₁ (i.e., S₁), of the transaction 706₁ (i.e., S₂), and of the transaction 707₁ (i.e., S₃); The snapshot block 710 stores the state snapshot of the transaction 705₂ (i.e., S₁′) as the state of the transaction chains 706 and 707 do not change; The snapshot block 711 stores state snapshots of the transaction 706₃ (i.e., S₂″). Thus, only one copy of the data in the snapshot will be stored, no matter how many transactions generated by a user between the two snapshots.

### Asynchronous Model

In certain embodiments, the methods disclosed herein use an asynchronous model on the consensus mechanism.

The life cycle of a transaction includes transaction initiation, transaction writing and transaction confirmation. In order to improve the performance of the system, these three steps are designed into asynchronous mode. This is because at different times, the quantity of transactions initiated by users is different, the speed of transaction writing and transaction confirmation processed by system is fixed relatively. Asynchronous mode helps to flatten the peaks and troughs thus improve the overall throughput of the system.

The asynchronous model of the Bitcoin and the Ethereum is simple: the transaction initiated by all users is placed in an unconfirmed pool. When a node finding a new block packages it into the new block, the transaction is written and confirmed at the same time. When the block chain continues to grow, the transaction eventually reaches the preset confirmation confidence level.

There are two problems in this asynchronous model. First, transactions are not persisted to ledgers in an unconfirmed state. Unconfirmed transactions are unstable, and there is no consensus involved, it can't prevent sending of transactions repeatedly. Second, there is no asynchronous mechanism for writing and confirming of transactions. Transactions are only written when confirmed, and the speed of writing is restricted by the confirmation speed.

In certain embodiments, the methods disclosed herein establish a more improved asynchronous model. First, the transaction is split into a transaction pair based on a “request-response” model, whether it is a transfer or a contract call, and the transaction is successfully launched when a request transaction is written to the ledger. In addition, the writing and confirming of a transaction is asynchronous as well. Transactions can be written into the users of the block lattice ledger first and will not be blocked by the confirmation process. Transaction confirmation is done through snapshot chain, and snapshot action is asynchronous too.

This is a typical producer-consumer model. In the life cycle of the transaction, no matter how production rate changes in the upstream, the downstream can deal with the transaction at a constant rate, so as to fully utilize the platform resources and improve the system's throughput.

It is appreciated that the Summary and Abstract sections may set forth one or more, but not all exemplary embodiments of the present invention as contemplated by the inventor(s), and thus, are not intended to limit the present invention and the appended claims in any way.

What is claimed is:

1. A method of digital asset transfer on a distributed ledger operated on a network, wherein the distributed ledger comprises a plurality of users, each user having a transaction chain comprising a series of transactions linked by hash reference, wherein the network comprises a plurality of nodes each having a processor, the method comprising:
a. receiving, by a first node of the network, a new transaction of a first user broadcast in the network;
b. verifying, by the first node, that the new transaction of the first user is valid;
c. in response to that the new transaction is valid, linking by the first node the new transaction by hash reference to a latest transaction of a first transaction chain of the first user;
d. taking, by a second node, a snapshot of the first user, said snapshot comprising the first user's balance in the new transaction of the first user and a hash of the new transaction of the first user;
e. generating, by the second node, a new snapshot block;
f. storing, by the second node, the snapshot of the first user in the new snapshot block; and
g. linking, by the second node, the new snapshot block to a latest snapshot block of a snapshot chain by referring to a hash of the latest snapshot block;
wherein the first node and the second node are the same node or different nodes.

2. The method of claim 1, wherein the distributed ledger has a structure of directed acyclic graph.

3. The method of claim 1, wherein the first transaction is a request transaction that sends an amount of digital asset to a second account, wherein the verifying step comprises:
a1. verifying that a hash of a previous transaction linked to the latest transaction is valid; and
a2. verifying that the first user's balance included the latest transaction is not less than the amount of digital asset.

4. The method of claim 1, wherein the first transaction is a response transaction that receives an amount of digital asset from a corresponding request block of a second account, wherein the verifying step comprises:
a1. verifying that a hash of a previous block linked to the latest block is valid; and
a2. verifying that the hash of the corresponding request block is valid.

5. The method of claim 1, wherein the new snapshot block is signed by the second node.

6. The method of claim 1, further comprising broadcasting the new snapshot block to the network.

7. A non-transitory readable storage medium including instructions, when executed by a processor in a node of a network, causes the processor to perform a method of digital asset transfer on a distributed ledger, wherein the distributed ledger comprises a plurality of users, each user having an transaction chain comprising a series of transactions linked by hash reference, the method comprising:
a. receiving, by a first node of the network, a new transaction of a first user broadcast in the network;
b. verifying, by the first node, that the new transaction of the first user is valid;
c. in response to that the new transaction is valid, linking by the first node the new transaction by hash reference to a latest transaction of a first transaction chain of the first user;
d. taking, by a second node, a snapshot of the first user, said snapshot comprising the first user's balance in the new transaction of the first user and a hash of the new transaction of the first user;
e. generating, by the second node, a new snapshot block;
f. storing, by the second node, the snapshot of the first user in the new snapshot block; and
g. linking, by the second node, the new snapshot block to a latest snapshot block of a snapshot chain by referring to a hash of the latest snapshot block;
wherein the first node and the second node are the same node or different nodes.

8. The non-transitory readable storage medium of claim 7, wherein the distributed ledger has a structure of directed acyclic graph.

9. The non-transitory readable storage medium of claim 7, wherein the first transaction is a request transaction that sends an amount of digital asset to a second user, wherein the verifying step comprises:
a1. verifying that a hash of a previous transaction linked to the latest transaction is valid; and
a2. verifying that the first user's balance included the latest transaction is not less than the amount of digital asset.

10. The non-transitory readable storage medium of claim 7, wherein the first transaction is a response transaction that receives an amount of digital asset from a corresponding request transaction of a second user, wherein the verifying step comprises:
a1. verifying that a hash of a previous block linked to the latest block is valid; and
a2. verifying that the hash of the corresponding request block is valid.

11. The non-transitory readable storage medium of claim 7, wherein the new snapshot block is signed by the second node.

12. The non-transitory readable storage medium of claim 7, wherein the method further comprises broadcasting the new snapshot block to the network.

13. A system for digital asset transfer on a distributed ledger, wherein the distributed ledger comprises a plurality of users, each user having a transaction chain comprising a series of transactions linked by hash reference, the system comprising a network which comprises a plurality of nodes, each node having a processor to perform a method, the method comprising:
a. receiving, by a first node of the network, a new transaction of a first user broadcast in the network;
b. verifying, by the first node, that the new transaction of the first user is valid;
c. in response to that the new transaction is valid, linking by the first node the new transaction by hash reference to a latest transaction of a first transaction chain of the first user;
d. taking, by a second node, a snapshot of the first user, said snapshot comprising the first user's balance in the new transaction of the first user and a hash of the new transaction of the first user;
e. generating, by the second node, a new snapshot block;
f. storing, by the second node, the snapshot of the first user in the new snapshot block; and
g. linking, by the second node, the new snapshot block to a latest snapshot block of a snapshot chain by referring to a hash of the latest snapshot block;
wherein the first node and the second node are the same node or different nodes.

14. The system of claim 13, wherein the first transaction is a request transaction that sends an amount of digital asset to a second account, wherein the verifying step comprises:
a1. verifying that a hash of a previous transaction linked to the latest transaction is valid; and
a2. verifying that the first user's balance included the latest transaction is not less than the amount of digital asset.

15. The system of claim 13, wherein the first transaction is a response transaction that receives an amount of digital asset from a corresponding request block of a second account, wherein the verifying step comprises:
a1. verifying that a hash of a previous block linked to the latest block is valid; and
a2. verifying that the hash of the corresponding request block is valid.

16. The system of claim 13, wherein the new snapshot block is signed by the second node.

17. The system of claim 13, wherein the method further comprises broadcasting the new snapshot block to the network.
